(19) United States
(12) Patent Application Publication
(10) Pub. No.: US 2023/0153585 A1
(43) Pub. Date: May 18, 2023

(54) Dual State Circuit for Energy Efficient Hardware Implementation of Spiking Neural Networks

(71) Applicant: University of Windsor, Windsor (CA)

(72) Inventors: Mitra MIRHASSANI, Windsor (CA); Moslem Heidarpur, Orleans (CA); Alexander John Leigh, Windsor (CA)

(21) Appl. No.: 17/984,612

(22) Filed: Nov. 10, 2022

Related U.S. Application Data
(60) Provisional application No. 63/278,763, filed on Nov. 12, 2021.

(51) Int. Cl. G06N 3/049

(52) U.S. Cl. CPC G06N 3/049

(57) ABSTRACT

In a preferred embodiment, there is provided a method for reducing power consumption in an artificial neural network, the method comprising: receiving an input signal; modulating a sampling frequency of an artificial neuron based on the input signal; and forwarding the input signal or a further input signal obtained from the input signal to the artificial neuron at the sampling frequency, wherein said modulating the sampling frequency comprises increasing the sampling frequency with an increased input signal and reducing the sampling frequency with a decreased input signal.

### RELATED APPLICATIONS

This application claims the benefit under 35 USC 119(e) to U.S. Provisional Application Ser. No. 63/278,763 filed 12 Nov. 2021, the entire contents of which are incorporated herein by reference.

### SCOPE OF THE INVENTION

The present invention relates to a method for reducing power consumption in an artificial or spiking neural network preferably by selectively reducing a sampling frequency based on an input, and which may not necessarily require modification to the neural network.

### BACKGROUND OF THE INVENTION

Hardware implementations of spiking neurons and Spiking neural networks (SNNs) are a subject of substantial research interest in the broad field of Artificial Intelligence (AI). Parallelism with real biological systems is central to such systems, and one of the most characteristic properties of real neural systems is their remarkably low power consumption in comparison to electrical hardware systems. Spiking neuron and neuroprocessor implementations have been proposed to provide power savings, which however require a specific technology node, neuron model, and/or hardware implementation technique. Additionally, among the diverse models of varying biological detail of spiking neuron behaviour, implementations concerned with power consumption often use the simplest and least biologically detailed models available.

Neuron models of low biological detail have been proposed to achieve power savings. These neuron models cannot replicate all behaviours of real biological neurons and the power savings are not replicable with a higher level of biological detail in these proposed implementations.

Moreover, most power-conscious neuron implementations are realized in analog or mixed-signal VLSI systems. Although analog implementations typically offer better power consumption properties than digital systems, they require extensive design consideration, are far more susceptible to noise, and are less precise than digital systems. Furthermore, the power consumption properties of analog systems are highly dependent on the technology node, implying that reported benefits in power consumption may not be transferrable to different technology processes.

Among the vast digital spiking neuron implementations, few works prioritize power optimization, and among these works a small portion report power consumption for their implemented neurons. Among the few digital implementations of biologically detailed neurons that report power consumption, specific hardware implementation techniques such as the CORDIC algorithm have been employed and shown to offer power savings. Although the CORDIC algorithm is effective in reducing hardware resource and power consumption, it is an iterative algorithm which lowers the system throughput and this approach to power reduction limits the flexibility in the hardware design to the use of a single technique. It is believed there has not yet been a proposed method by which the power consumption of any designed digital neuron regardless of the target model can be reduced.

In designing SNNs, one of the more important considerations is the design of the spiking neurons used in the network. Many mathematical neuron models have been proposed with varying levels of biological detail and description. Since neurons are dynamical systems, meaning they are neither linear nor time-invariant, implementing spiking neuron hardware systems presents a specific and substantial set of design challenges and considerations. Firstly, the implemented neuron must faithfully follow the behaviour of the target neuron model, exhibiting similar behavioural characteristics and bifurcations. Simultaneously, biological neurons highly efficient, exhibiting low power consumption, and are additionally physically very small. The power efficiency is due in part to the fact that biological neurons are active only when receiving stimulus. Thus, low power consumption and hardware resource usage are critical as these factors are parallel with biology and permissive of larger SNNs.

To remedy this need for reduced power consumption in digital neurons, it was noted that in real biological neural systems, neurons are inactive most of the time. This inactivity is how biological systems achieve their low-power operation. A method by which inactivity is included in the digital neuron is proposed that can be applied to any neuron model to greatly reduce its power consumption. This method is parallel to the inactivity observed in real biological neurons for low stimulus.

### SUMMARY OF THE INVENTION

The applicant has recognized an approach to digital hardware implementations of, for example, spiking neurons, where the system evaluates the neuron's differential equations at a frequency dependent on input current using a sampling-based approach. The variability in the frequency of the sampling may reduce unnecessary switching activity for low-stimulus states. This Input-DEpendent Variable Sampling (I-DEVS) method to spiking neuron implementation may result in neurons with reduced additional hardware resource usage in exchange for improved dynamic power savings as the switching activity may be greatly reduced compared to traditional neuron implementations. Furthermore, the behaviour of the neuron may remain unaltered using the approach.

A possible non-limiting object of the present invention is to provide a method for operating or reducing power consumption an artificial neural network, such as, but not limited to, a spiking neural network, and which may permit dynamic reduction of power required by digital spiking neuron implementation or implemented neurons.

Another possible non-limiting object of the present invention is to provide a method for operating or reducing power consumption in an artificial neural network, and which may more closely mimic operation or behavior of biological neurons in response to differing stimuli.

Another possible non-limiting object of the present invention is to provide a method for operating or reducing power consumption in an artificial neural network, and which may permit a sampling-based approach to provide periods of reduced neuron activity without necessarily significantly affecting accuracy or stability of artificial neuron output signal.

Another possible non-limiting object of the present invention is to provide a method for operating or reducing power consumption in an artificial neural network, and which may permit application or implementation with various neuron models and over a wide range of input or input signals.

In one simplified aspect, there is provided a method for operating an artificial or spiking neural network, the method comprising modulating a sampling frequency of an artificial neuron in a generally inversely proportional relationship to an input signal or in a generally inversely exponentially proportional relationship to an input signal.

In another simplified aspect, there is provided a method for operating an artificial or spiking neural network, the method comprising modulating a sampling frequency of an artificial neuron based on an input signal and reference sampling frequencies, the reference sampling frequencies being determined at a plurality of respective preselected input signal amplitudes, whereby an output or output signal of the artificial neuron from each said preselected input signal amplitude is stable at or above the associated reference sampling frequency.

In one preferred aspect, there is provided a method for operating an artificial neural network, the method comprising: receiving an input signal; modulating a sampling frequency of an artificial neuron based on the input signal; and forwarding the input signal or a further input signal obtained from the input signal to the artificial neuron at the sampling frequency, wherein said modulating the sampling frequency comprises one or both of increasing the sampling frequency with an increased input signal and reducing the sampling frequency with a decreased input signal.

In another preferred aspect, there is provided a method for operating a spiking neural network, the method comprising: receiving an input current; determining a time step based on the input current; starting a timer; and forwarding the input current to an artificial neuron when the timer reaches the time step for a time period selected for the artificial neuron to perform a single evaluation.

In yet another preferred aspect, there is provided a spiking neural network comprising an input-dependent variable sampling module and a digital neuron module, the input-dependent variable sampling module being configured to: receive an input current to be compared to a threshold value and select a first predefined time step if the input current is less than the threshold value and a second predefined time step if the input current is more than the threshold value; start a timer; and forward the input current to the digital neuron module when the timer reaches a selected one of the first and second predefined time steps for a time period selected for the digital neuron module to perform a single evaluation, wherein the first predefined time step is longer than the second predefined time step.

In one embodiment, said modulating the sampling frequency comprises modulating the sampling frequency based on an amplitude of the input signal and one or more reference sampling frequencies, wherein the reference sampling frequencies are determined at a plurality of preselected input signal amplitudes, whereby an output or output signal of the artificial neuron from each said preselected input signal amplitude is substantially stable at or above the associated reference sampling frequency.

In one embodiment, said modulating the sampling frequency comprises selecting one of two or more predefined sampling frequencies based on an amplitude of the input signal, each said predefined sampling frequency being selected for a range of the amplitude of the input signal, whereby the output or output signal of the artificial neuron from the amplitude of the input signal in at least a portion of the range is substantially stable at or about the associated predefined sampling frequency.

In one embodiment, said modulating the sampling frequency comprises selecting one of two or more predefined sampling frequencies obtained from the reference sampling frequencies, each said predefined sampling frequency being selected for a range of the amplitude of the input signal, whereby the output or output signal of the artificial neuron from the amplitude of the input signal in at least a portion of the range is substantially stable at or about the associated predefined sampling frequency.

In one embodiment, said modulating the sampling frequency comprises selecting one of two, three, four or five predefined sampling frequencies. In one embodiment, said modulating the sampling frequency comprises selecting one of three predefined sampling frequencies. In one embodiment, the predefined sampling frequencies comprise dt= 1/16 ms, dt= 1/32 ms and dt= 1/64 ms. It is to be appreciated, however, the method may be performed with more than five predefined sampling frequencies and at other frequencies.

In one embodiment, each said predefined sampling frequency is substantially equal to at least one said reference sampling frequency determined at the associated preselected input signal amplitude falling within the associated range. In one embodiment, each said predefined sampling frequency is substantially equal to one said reference sampling frequency determined at the associated preselected input signal amplitude proximal to a lowest or highest end of the associated range. In an alternative embodiment, each said predefined sampling frequency is selected based on two or more said reference sampling frequencies determined at the associated preselected input signal amplitudes falling within the associated range. In one embodiment, each said predefined sampling frequency is selected based on all said reference sampling frequencies determined at the associated preselected input signal amplitudes falling within the associated range.

In one embodiment, the output or output signal of the artificial neuron from the amplitude of the input signal in the range is substantially stable at or about the associated predefined sampling frequency.

In one embodiment, said modulating the sampling frequency comprises: i) modulating the sampling frequency to be about equal to or greater than one said reference sampling frequency if the amplitude of the input signal is substantially identical to one said preselected input signal amplitude associated with the reference sampling frequency; and ii) if the amplitude of the input signal is different from all said preselected input signal amplitudes, modulating the sampling frequency to be about equal to or great than an estimated sampling frequency interpolated or extrapolated from one or more said reference sampling frequencies, which are preferably determined at the associated preselected input signal amplitudes proximal to the amplitude of the input signal. In one embodiment, said modulating the sampling frequency comprises: i) modulating the sampling frequency to be about equal to one said reference sampling frequency if the amplitude of the input signal is substantially identical to one said preselected input signal amplitude associated with the reference sampling frequency; and ii) if the amplitude of the input signal is different from all said preselected input signal amplitudes, modulating the sampling frequency to be about equal to an estimated sampling frequency interpolated or extrapolated from one or more said reference sampling frequencies, which are preferably determined at the associated preselected input signal amplitudes proximal to the amplitude of the input signal. In one embodiment, the estimated sampling frequency is selected to provide a substantially stable output or output signal of the artificial neuron from the amplitude of the input signal.

In one embodiment, the input signal is an input current.

In one embodiment, the artificial neural network is a spiking neural network.

In one embodiment, the artificial or spiking neural network comprises a digital neuron model selected from the group consisting of Adaptive-Exponential Integrate-and-Fire model, Izhikevich model, Hodgkin-Huxley model, Leaky Integrate-and-Fire model, Thorpe's model, probabilistic and stochastic spiking neuron model and probabilistic neurogenetic model.

In one embodiment, the digital neuron model is Adaptive-Exponential Integrate-and-Fire model or Izhikevich model, and said modulating the sampling frequency comprises selecting the sampling frequency between dt= 1/4096 ms and dt=8 ms. In one embodiment, said modulating the sampling frequency comprises selecting the sampling frequency between dt= 1/2048 ms and dt=4 ms, between dt= 1/1024 ms and dt=1 ms, between dt= 1/512 ms and dt=¼ ms or between dt= 1/64 ms and dt= 1/16 ms.

In one embodiment, the method is operable to reduce power consumption in the artificial neural network.

In one embodiment, said determining the time step comprises determining the time step generally inversely proportional to the input current. In one embodiment, said determining the time step comprises determining the time step generally inversely exponentially proportional to the input current. It is to be appreciated, however, that the relationship between the time step and the input current may depend on the behavior of the specific artificial neural network.

In one embodiment, the sampling frequency is an inverse of the time step. In such embodiment, all description relating to sampling frequency provided herein, such as that provided above, applies to description relating to time step.

In one embodiment, said determining the time step comprises determining the time step based on the input current and one or more reference time steps, wherein the reference time steps are determined at a plurality of preselected input currents, whereby an output or output signal of the artificial neuron from each said preselected input current is substantially stable at or lower than the associated time step.

In one embodiment, said determining the time step comprises selecting one of two or more predefined time steps based on the input current, each said predefined time step being selected for a range of the input current, whereby the output or output signal of the artificial neuron from the input current in at least a portion of the range is substantially stable at or about the associated predefined time step.

In one embodiment, said determining the time step comprises selecting one of two or more predefined time steps obtained from the reference time steps, each said predefined time step being selected for a range of the input current, whereby the output or output signal of the artificial neuron from the input current in at least a portion of the range is substantially stable at or about the associated predefined time step.

In one embodiment, each said predefined time step is substantially equal to at least one said reference time step determined at the associated preselected input current falling within the associated range.

In one embodiment, the output or output signal of the artificial neuron from the input current in the range is substantially stable at or about the associated predefined time step.

In one embodiment, said determining the time step comprises: i) determining the time step to be about equal to or lower than one said reference time step if the input current is substantially identical to one said preselected input current associated with the reference time step; and if the input current is different from all said preselected input currents, determining the time step to be about equal to or lower than an estimated time step interpolated or extrapolated from one or more said reference time steps.

In one aspect, there is provided a method for reducing power consumption in an artificial neural network, the method comprising: receiving an input signal; modulating a sampling frequency of an artificial neuron based on the input signal; and forwarding the input signal or a further input signal obtained from the input signal to the artificial neuron at the sampling frequency, wherein said modulating the sampling frequency comprises increasing the sampling frequency with an increased input signal and reducing the sampling frequency with a decreased input signal.

In another aspect, there is provided a method for reducing power consumption in an artificial neural network, the method comprising: receiving a first input current and determining a time step based on the first input current; starting a timer for counting one or more clocks; forwarding a second input current derived from the first input current, the time step and one said clock to a digital neuron model when the timer reaches a threshold determined by the time step; outputting a sampled membrane potential from the digital neuron model; and disabling the digital neuron model.

In yet another aspect, there is provided a method for reducing power consumption in a spiking neural network, the method comprising: receiving an input current and a clock and determining a time step based on the input current, wherein the time step is generally inversely proportional to the first input current; starting a timer comprising a counter for tracking one or more clock cycles and when the counter reaches the time step, forwarding the input current, the time step and the clock to a digital neuron model, whereby the digital neuron model performs one or more calculations; and outputting a sampled membrane potential from the digital neuron model; and disabling the digital neuron model.

In yet another aspect, there is provided an artificial neural network comprising an input-dependent variable sampling module and a digital neuron module coupled to the input-dependent variable sampling module, wherein the input-dependent variable sampling module comprises a comparator and a timer component, the comparator being for receiving an input current and comparing the input current to a threshold determined by the digital neuron module, and the timer component being for receiving a clock input, wherein the input-dependent variable sampling module outputs a sampling frequency based on the input current and forwards the input current and the clock input, wherein the digital neuron module comprises a clock input component, an f-sample component and an input current component respectively being for receiving the clock input, the sampling frequency and the input current, and the digital neuron module outputs a sampled membrane potential, and wherein the sampling frequency is generally inversely proportional to the input current.

In one embodiment, the input signal is an input current. It is to be appreciated that the input current is not particular limited, provided that the input current may be compared or processed and forwarded to the digital neuron model. In one embodiment, the input current is between about 1 μA and about 5000 μA, between about 2 μA and about 4000 μA or between about 5 μA and about 2000 μA.

It is to be appreciated that the artificial neural network and the digital neuron model are not particular limited, provided that the method may be implemented in the artificial neural network or with the digital neuron model. In one embodiment, the artificial neural network is a spiking neural network. In one embodiment, the spiking neural network comprises spiking neurons. In one embodiment, the spiking neural network uses spikes for information representation. In one embodiment, the digital neuron model is selected from the group consisting of Adaptive-Exponential Integrate-and-Fire model, Izhikevich model, Hodgkin-Huxley model, Leaky Integrate-and-Fire model, Thorpe's model, probabilistic and stochastic spiking neuron model and probabilistic neurogenetic model. In one embodiment, the digital neuron model comprises Adaptive-Exponential Integrate-and-Fire model or Izhikevich model, and said modulating the sampling frequency or determining the time step comprises selecting the sampling frequency or the time step between dt= 1/4096 ms and dt=8 ms. It is to be appreciated that the sampling frequency or the time step can have different ranges, depending on a number of factors, including identity of the digital neuron model.

In one embodiment, said determining the time step comprises determining the time step generally inversely proportional to the first input current.

In one embodiment, the method further comprises ending the timer when the counter reaches the time step. In one embodiment, said one or more calculations comprise one or more differential equations. In one embodiment, said determining the time step is performed after every iteration of the method.

### BRIEF DESCRIPTION OF THE DRAWINGS

Reference may now be had to the following detailed description taken together with the accompanying drawings in which:

FIG. 1 shows a block diagram showing a high-level summary of an I-DEVS neuron method in accordance with a preferred embodiment of the current invention;

FIG. 2 shows eight (8) line graphs illustrating membrane potential waveform of AdEx (graphs (a) to (d)) and Izhikevich (graphs (e) to (h)) neurons for different time steps, where the time step in graphs (a) and (e) is dt= 1/1024 ms; that in graph (b) dt= 1/16 ms; that in graph (c) dt=¼ ms; that in graphs (d) and (g) dt=2 ms; that in graph (f) dt=⅛; that in graph; and that in graph (h) dt=4;

FIG. 3 shows two (2) line graphs illustrating the threshold time steps that the AdEx (graph (a)) and Izhikevich (graph (b)) neurons become unstable as function of input current;

FIG. 4 shows four (4) line graphs illustrating simulations of the AdEx Neuron with and without a variable time step for a triangular wave current, where graph (a) shows the membrane potential of an AdEx neuron with a fixed time step dt= 1/512; graph (b) the membrane potential of an AdEx neuron with the I-DEVS method; graph (c) the input current; and graph (d) the value of dt as a function of time, and thus transitively input current;

FIG. 5 shows four (4) line graphs illustrating simulations of the Izhikevich Neuron with and without a variable time step for a triangular wave current, where graph (a) shows the membrane potential of an Izhikevich neuron with a fixed time step of dt= 1/512; graph (b) the membrane potential of an Izhikevich neuron with the I-DEVS method; graph (c) the input current; and graph (d) the value of dt as a function of time, and thus transitively input current;

FIG. 6 shows a block diagram of a digital hardware implementation I-DEVS module in accordance with a preferred embodiment of the present invention;

FIG. 7 shows two (2) bar graphs illustrating computational savings per time from the I-DEVS method compared to traditional implementations for the AdEx and Izhikevich neurons, where graph (a) shows the savings in difference equation evaluations and graph (b) the savings in clock cycles for which the neuron is active;

FIG. 8 shows oscilloscope measurements for (a) to (c) an AdEx Neuron implemented using traditional hardware implementation, and (d) to (f) the same neuron implemented using the I-DEVS method, where the neuron's membrane potential is shown in blue and the input current is shown in yellow, and (a) and (d), (b) and (e), and (c) and (f) show corresponding input currents;

FIG. 9 shows oscilloscope measurements for (a) to (c) an Izhikevich Neuron implemented using traditional hardware implementation, and (d) to (f) the same neuron implemented using the I-DEVS method, where the neuron's membrane potential is shown in blue and the input current is shown in yellow, and (a) and (d), (b) and (e), and (c) and (f) show corresponding input currents.

### DETAILED DESCRIPTION OF THE PREFERRED EMBODIMENTS

It is to be appreciated that although the method may be applied to a number of biologically detailed neuron, as a case study, two spiking neurons, the Adaptive-Exponential Integrate-and-Fire (AdEx) model (see R. Brette and W. Gerstner, “Adaptive exponential integrate-and-fire model as an effective description of neuronal activity,” J Neurophysiol, pp. 3637-3642, July 2005, the entire contents of which are incorporated herein by reference) and the Izhikevich model (E. M. Izhikevich, “Simple model of spiking neurons,” IEEE Trans. Neural Netw., vol. 14, pp. 1569-1572, November 2003, the entire contents of which are incorporated herein by reference), were designed and implemented on an FPGA using a method in accordance with a preferred embodiment of the present invention. The novel I-DEVS sampling-based method may limit the number of times the differential equation is evaluated in the hardware system, meaning idle clock cycles are permissible when possible in the system which greatly reduces the power consumption of the neuron. The proposed implementation's inclusion of idle time for low stimulus may be analogous to the behaviour of real biological neurons under low-stimulus operational conditions, which allows for the low-power operation of the human nervous system. The unique approach allows for a large range of input current for which the neuron remains stable, while also allowing for a reduction in power consumption and uninhibited neuron performance.

### Neuron Modelling

Two neuron models were tested for implementation, namely the Izhikevich Model and the AdEx Model, both of which are characterized by a pair of differential equations that describe neuronal behaviour. The discretized form of the Izhikevich Model describes neuronal behaviour with the following two equations and reset condition:

$$v [ n + 1 ] = v [ n ] + dt ( 0.04 {v}^{2} + 5 v + 140 - u + I ) \qquad ( 1 )$$

$$u [ n + 1 ] = u [ n ] + dt ( a ( bv - u ) ) \qquad ( 2 )$$

$$if v [ n ] \geq 30 mV , then \{ \begin{matrix}v \to c \\ u \to u + d\end{matrix} \qquad ( 3 )$$

where v is the membrane potential, I is the input synaptic current, u is an auxiliary variable, c is the reset potential, a, b, and d are model parameters, and dt is the time step.

After discretization by the Euler method, the AdEx neuron model is given by:

$$V [ n + 1 ] = v [ n ] + dt \frac{1}{C} ( - {g}_{L} ( V - {E}_{L} ) + {g}_{L} {Δ}_{T} {e}^{\frac{V - {V}_{T}}{{Δ}_{T}}} - {g}_{e} [ n ] ( V - {E}_{e} ) - {g}_{i} [ n ] ( V - {E}_{i} ) - w ) \qquad ( 4 )$$

$$w [ n + 1 ] = w [ n ] + dt \frac{1}{{τ}_{w}} ( a ( V - {E}_{L} ) - w ) \qquad ( 5 )$$

$$if v [ n ] \geq 20 mV , then \{ \begin{matrix}V \to {E}_{L} \\ w \to w + b\end{matrix} \qquad ( 6 )$$

where C is the membrane capacitance, gL is the leak conductance, E_{L} is the leak reversal potential, V_{T} is the spike threshold, Δ_{T} is the slope factor, τ_{w} is the adaptation time constant, a is the subthreshold adaptation, b is the spike-triggered adaptation, and dt is the time step.

It is noted previous digital implementations of the AdEx and Izhikevich neuron models focused primarily on hardware design techniques that reduce resource requirements. Many acknowledge the significance of power consumption, but do not include detailed power analysis. Given the significant advantages of digital neuron hardware implementations, namely their accuracy and tolerance for noise, it has been recognized that power consumption is a significant topic to address to ameliorate digital neuron designs and make them more accurate to real biology.

### Methodology

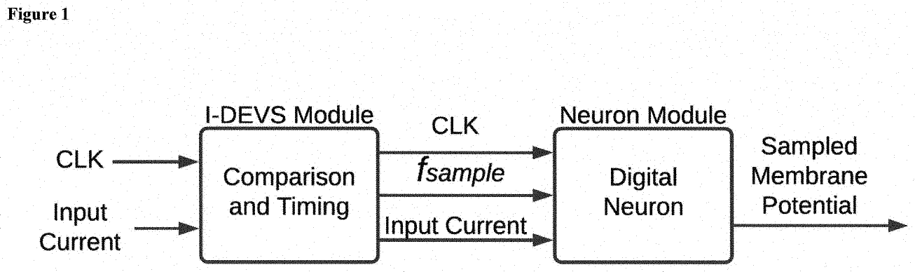

Analogous behaviour to real biological neurons was considered for the development of the I-DEVS neuron implementation method. The stimulus-dependent activity of real neurons allows for the low-power operation of biological nervous systems, and in homology the I-DEVS method was configured to allow inactivity to be included in the neuron's behaviour at a proportion determined by the input stimulus. FIG. 1 shows a block diagram of an I-DEVS method in accordance with a preferred embodiment. As seen in FIG. 1, the input current and clock input to a comparator and timer block, where the input is compared to a threshold determined by the neuron model. Based on the input current, the timer and time step used in the neuron discretization are set. Once the timer reaches a value that is set dependent on the input current, the current, clock, and time step of discretization are passed to the neuron for the time period necessary for the neuron to perform one evaluation, then the neuron's input and clock are disabled again. This effectively samples the neuron's output membrane potential at a variable sampling frequency.

It has been appreciated that the variability in the sampling may be important to allowing the neuron to produce valid, uncorrupted output for a wide domain of input current while avoiding unnecessary switching in the digital neuron for low input stimulus. The sampling-based approach allows for large amounts of inactivity in the neuron circuit, which greatly reduces the digital switching activity, leading to a reduced dynamic power consumption in the system. It has been appreciated that the I-DEVS method is not restricted to particular neuron model or digital hardware architecture and may not necessarily require modification to utilize the method.

### Simulations for Validation and Design Formulation

Software simulations were conducted to evaluate the stability and validity of the behaviours of both the AdEx and Izhikevich neuron models for varying input currents for a given sampling frequency. To successfully realize a neuron with a variable time step, it was first necessary to assess the effects of the size of the time step on the valid input current range as well as the power consumption associated with a given time step.

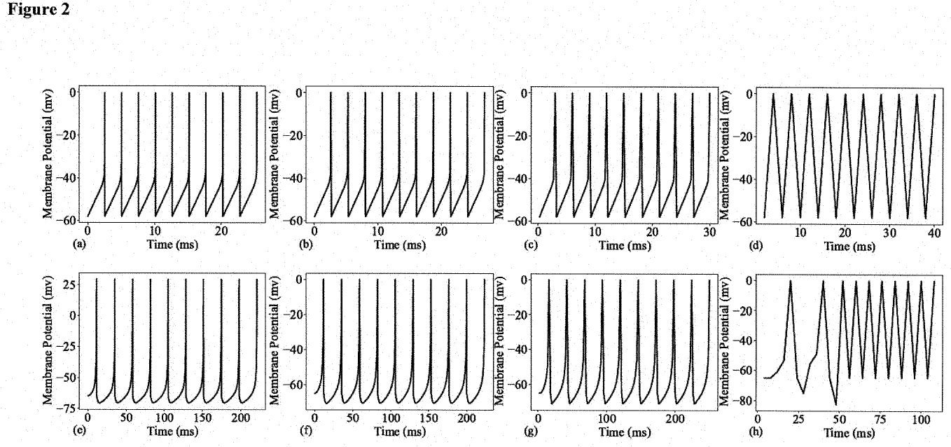

FIG. 2 shows simulations of both neuron models for a constant input current with varying time step. It is evident from FIG. 2 that a large time step has an adverse effect on the accuracy of the neuron's membrane potential. However, it is also clear that the smallest possible time step is not always necessary for high accuracy, meaning a time step below a given size for a given input current will result in redundant and unnecessary additional calculations of the neuron's differential equations. There was no visible qualitative change between FIG. 2 (a) and (b) (Izhikevich neuron for dt= 1/1024 and dt= 1/16) or between (e) and (0 (AdEx neuron for dt= 1/1024 and dt=⅛), which means for that given input current a time step smaller than 1/16 is not necessary to achieve desired behaviour.

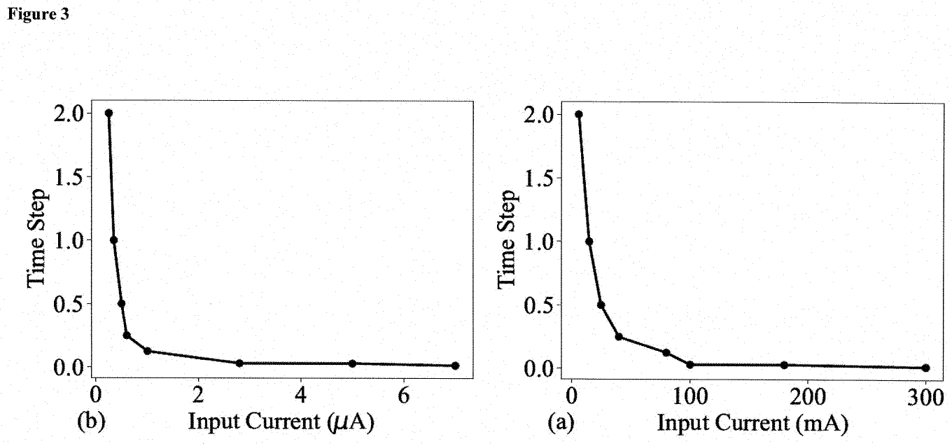

FIG. 3 shows the value of the time step and current for which each neuron becomes unstable, which directly correlates to stability at a given sampling frequency in digital hardware. As expected, higher current input requires a smaller time step to maintain stability in the neuron's output. FIG. 3 provides useful information for the design of a variable time step system as the points at which the time step should change can be inferred from the curve. It logically follows that a lower time step results in a greater valid input current domain.

Using the information gathered from simulation, a system was designed in which the time step of the neuron discretization is variable. The time step assumes one of three different values depending on the input current applied to the neuron. The threshold time steps found from FIG. 3 were used to determine the proper transition points for the time step in the domain of the input current.

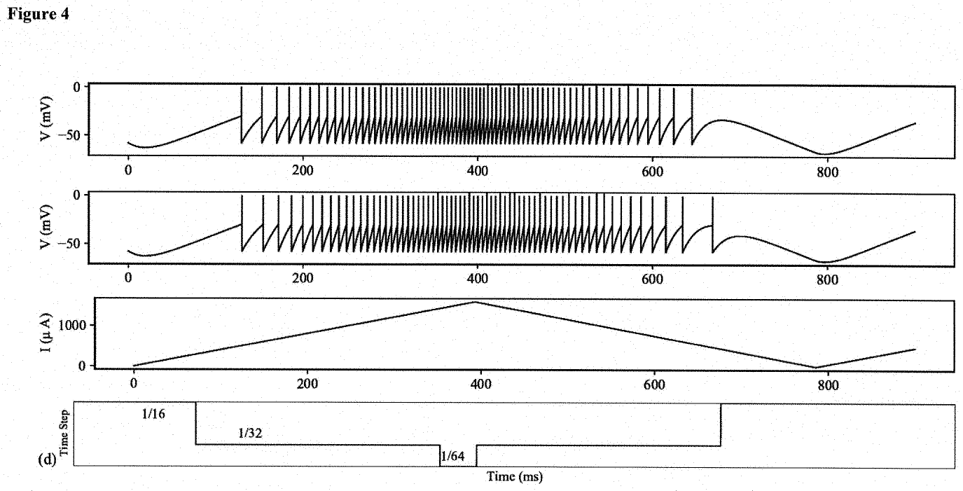

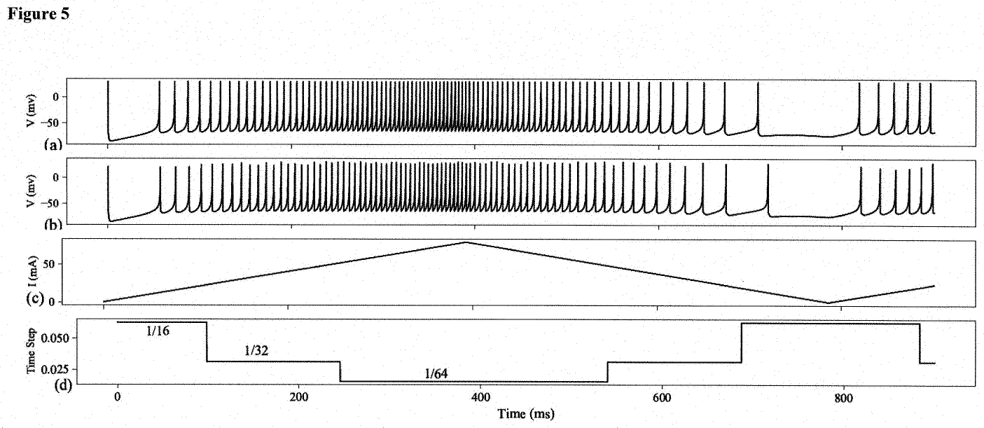

FIGS. 4 and 5 show simulations of the proposed neurons with variable time step. It is evident that the stability of the neuron is maintained for a large range of current. However, the unnecessarily high computation time and power consumption associated with a high time step is avoided for input current values for which it is not necessary. In digital hardware, the use of a high time step for low input currents to avoid unnecessary calculation translates to lower switching activity, which implies lowered dynamic power consumption.

### Validation in Digital Hardware—Hardware Design

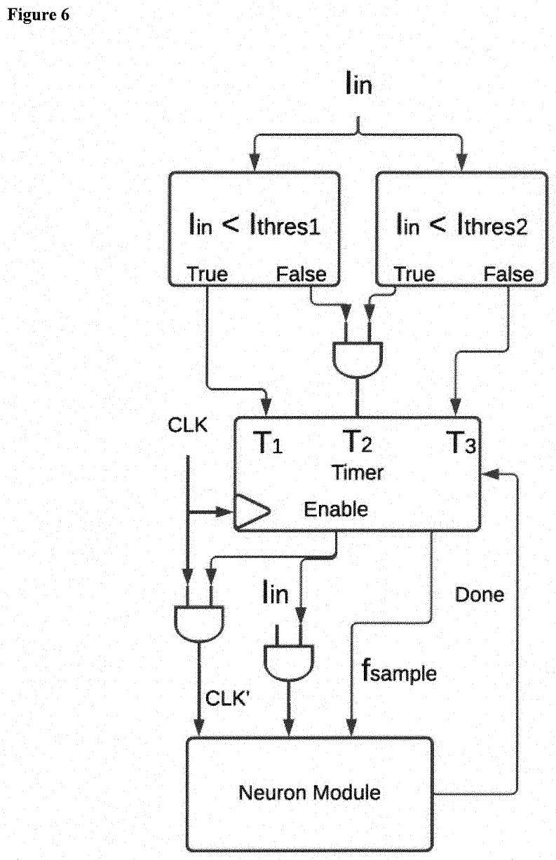

Preferred neuron systems were implemented on FPGA. Consistent implementations for both the AdEx and Izhikevich neuron were used between the I-DEVS and the traditional implementations. The AdEx neuron was implemented in Verilog using a 37-bit signed fixed-point implementation with 1 sign bit, 13 integer bits, and 23 fractional bits. The digital word length was selected to accommodate the CORDIC algorithm used for the implementation of the exponential term in the AdEx neuron model. The Izhikevich neuron was implemented in VHDL using a 33-bit signed fixed point with 1 sign bit, 18 integer bits, and 14 fractional bits. The v2 in the Izhikevich neuron model was implemented using a DSP multiplier. Although this is arguably not ideal for neuron implementations, the primary focus of this work is validation of the independence of the I-DEVS method on the architecture of the neuron, so diverse neuron implementation architectures were explored. In both neurons, the I-DEVS module was implemented using a state machine to control a comparator to the input current, and an 8-bit timer with three settings based on the input current range. The timer is used to determine when to pass the clock and input current to the neuron to acquire another sample. FIG. 6 shows a block diagram of the I-DEVS hardware module.

The effectiveness of the preferred I-DEVS method was assessed firstly in simulations to verify that the implemented hardware systems exhibit the target functionality. Functional simulations were successful. It was noted that the spike frequency of the neurons implemented using the I-DEVS method was lower than those of the traditional hardware implementations. This was observed in software simulations as well and was expected as more points of the difference equations are computed per unit time. This does not affect the bifurcative behaviours of the neurons since bifurcation analysis is performed independently of the discretized neuron, meaning that their network performance will be uninhibited as the final synaptic weights of a trained network will be different in compensation for the different spike frequencies.

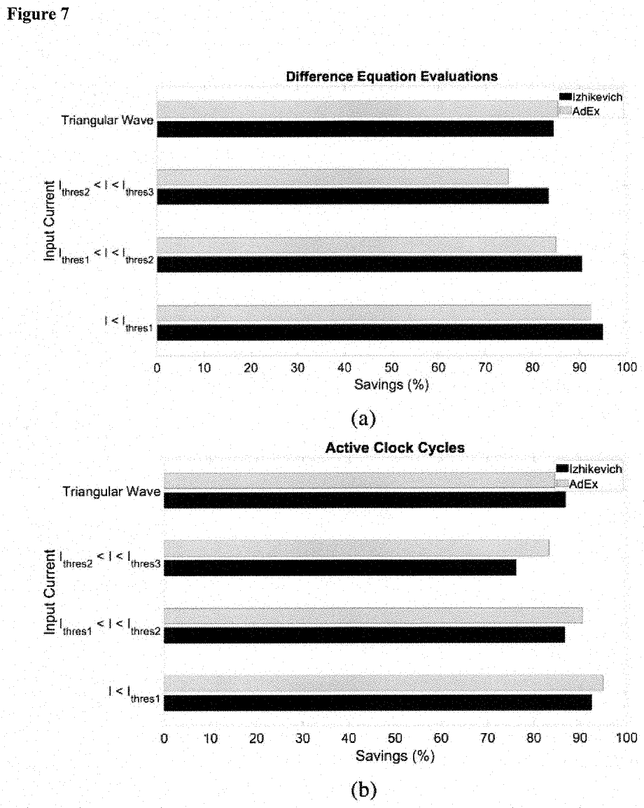

Furthermore, the projected savings in circuit switching activity were assessed. To validate theoretical expectations, the number of times each implementation evaluates the neuron's difference equations per average time was evaluated through functional simulation of the implemented neurons for different ranges of input current. FIG. 7 shows the savings in evaluations per time as well as the savings in the number of clock cycles for which the neuron is actively performing calculations. The substantial savings in activity implies reductions in switching activity in the system, which leads to reductions in power consumption. The third threshold current, Iₜₕᵣₑₛ₃, shown in FIG. 7 denotes the input current at which the output becomes corrupt for the smallest time step used in the systems of dt= 1/128. It is important to note that this threshold was not implemented since input current in this range does not contribute significant information to the behaviour of the neuron models.

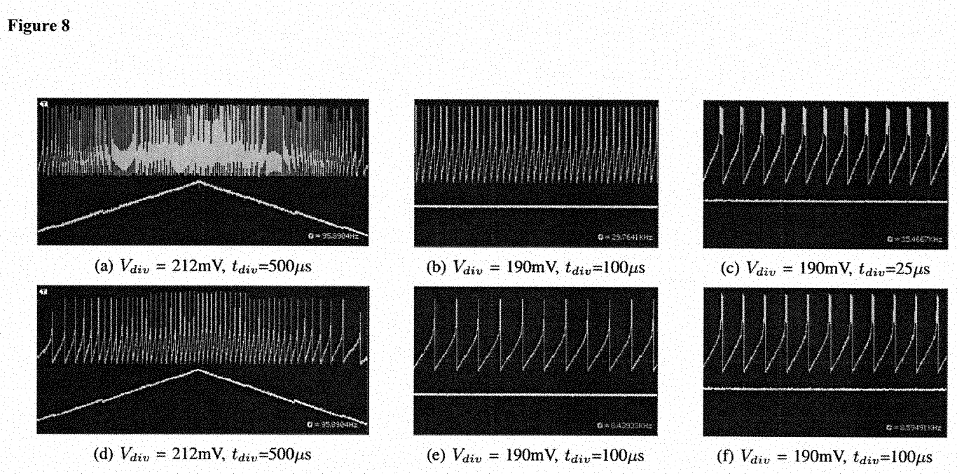

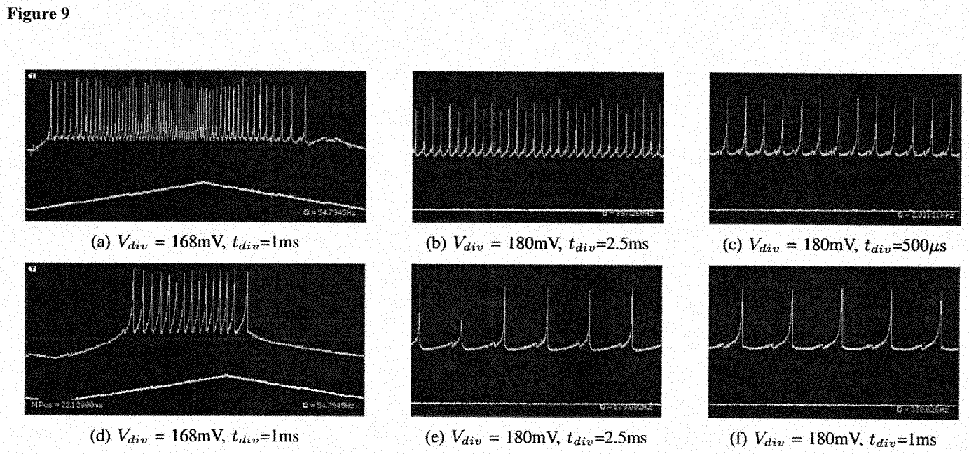

The system was implemented and validated on an Altera DE0 development board. For comparison, traditional implementation methods were implemented and tested as well alongside the I-DEVS neurons. FIGS. 8 and 9 show oscilloscope images for both the implemented AdEx and Izhikevich models. The digital membrane voltage was converted to an analog signal using a 12-bit resistive ladder for digital-to-analog conversion to view the waveform on the oscilloscope. It is evident that the behaviour of the implemented neuron is consistent with expectations. Although the I-DEVS neurons exhibit lower spiking frequencies than their fixed time step counterparts, the I-DEVS and traditional implementations exhibit consistent spiking behaviour for a given input current.

The prominence of the spike frequency difference was observed to be greater in the digital hardware implementations compared to the software simulations. This can be explained by the number of clock cycles required to evaluate the neuron's difference equations in hardware. Since both neurons were implemented using state machines (and in the case of the AdEx neuron, with an iterative algorithm), more than one clock cycle is required to evaluate the difference equations, which lowers the effective sampling frequency compared to simulation. Adjustments to the I-DEVS module's timer values could compensate if a higher spike frequency is necessary for a given application. However, it is important to note again that the I-DEVS method does not change the bifurcative behaviour of the neuron, meaning traditional neuron implementations and I-DEVS neuron implementations exhibit the same behaviour.

Furthermore, Table I below shows the FPGA hardware resource usage information for each neuron implemented both with a fixed time step and with the I-DEVS method on the Xilinx Spartan 7 FPGA. It is obvious that the I-DEVS method used to greatly reduce the neuron's power consumption presents a very minor trade-off in hardware usage.

TABLE I
FPGA Resource Usage Information on the Xilinx Spartan 7 for
neuron implementations with and without the I-DEVS method.

| Neuron Model | LUT | FF | DSP | I/O | Max. Clock (MHz) |
|---|---|---|---|---|---|
| AdEx | 1338 | 479 | 0 | 108 | 120.31 |
| AdEx I-DEVS | 1582 | 510 | 0 | 115 | 119.42 |
| Izhikevich | 397 | 194 | 4 | 67 | 249.25 |
| Izhikevich I-DEVS | 451 | 217 | 4 | 67 | 249.25 |

### Power Analysis

The power consumption of the variable time step neurons was analyzed using Vivado's Power Estimator and compared with the power consumption of fixed time step implementations. Using Vivado's Power Analysis tool, the FPGA implementations showed a 16.67% best case power reduction. Although this is inconsistent with the much larger anticipated power savings, it is noted that FPGA implementations are limited in their power savings by the architecture of the FPGA. To better capture the power savings offered by the I-DEVS method, the neurons were synthesized in Synopsys and the power consumption was estimated for a digital ASIC design. Table II shows power consumption information for the original and I-DEVS neurons. The substantial power savings shown are consistent with the expectations associated with the savings in switching activity at a clock frequency of 50 MHz. As expected, the power savings are lower than the computation savings due to parasitic elements in the ASIC implementation that are prominent with circuitry on fast-switching lines such as the clock line in digital systems. Furthermore, the power consumption is much lower in ASIC implementation estimations for all neurons as expected due to the architecture of the FPGA.

TABLE II
Dynamic Power Estimates for a 50 MHz clock for ASIC and
FPGA digital implementations of the AdEx and Izhikevich
neurons using the I-DEVS method. Note that the I-DEVS
column for power reports from [10] is used to report
the power consumption of the CORDIC implementation.

| | | Neuron | Original | I-DEVS | Savings |
|---|---|---|---|---|---|
| Clock | | Model | (mW) | (mW) | (%) |
| 50 MHz | ASIC | AdEx | 4.4733 | 1.4662 | 67.22 |
| | | Izhikevich | 2.0344 | 0.69369 | 65.90 |
| | FPGT | AdEx | 18 | 15 | 16.67 |
| | | Izhikevich | 7 | 7 | 0 |
| 10 MHz | ASIC | Izhikevich | 0.4081 | 0.1391 | 65.91 |
| 9.1 MHz | | Izhikevich [10] | 1.06 | 0.33 | 68.87 |

Since the power consumption of a digital Izhikevich neuron is reported for a clock frequency of 9.1 MHz, Synopsys power estimates were also collected for a clock frequency of 10 MHz for the Izhikevich implementation to create a fair comparison. As shown below, the I-DEVS method offered very similar power savings without imposing restrictions on the neuron's implementation architecture.

It is also important to note again that the AdEx neuron used in this study was implemented using the CORDIC algorithm for both the I-DEVS and traditional neuron, and the Izhikevich neuron was implemented using DSP multipliers in both cases. Different design approaches, digital word lengths, and neuron models were used to support the assertion that the I-DEVS method can reduce the power consumption for neurons of higher biological detail independent of the architecture of the neuron.

Although the relationship of the switching activity savings shown in FIG. 7 to the power savings reported in Table II is not directly proportional, there is a clear and evident relationship between the switching activity and the dynamic power consumption of the neuron. Thus, the I-DEVS method may be highly effective in reducing dynamic power consumption through the inclusion of inactivity in the neuron.

Two spiking neurons were implemented in digital hardware via FPGA with a preferred I-DEVS sampling-based digital neuron implementation method. The valid input current domain is substantially large, and simultaneously the implementation exhibited a lower power consumption compared to traditional implementations with fixed small time step as unnecessary active computation time for lower input currents is avoided. The I-DEVS method showed consistent reductions in switching activity and thus reductions in dynamic power consumption in the neuron independent of the neuron model and implementation method of the neuron module.

The application of the I-DEVS method may provide advantages for neurons to be used in SNNs as the power consumption is a metric and consideration for SNN design. Reduced dynamic power consumption of neurons implemented using the I-DEVS method may offer potential for larger networks of biologically detailed neurons.

While the invention has been described with reference to preferred embodiments, the invention is not or intended by the applicant to be so limited. A person skilled in the art would readily recognize and incorporate various modifications, additional elements and/or different combinations of the described components consistent with the scope of the invention as described herein.

We claim:

1. A method for operating an artificial neural network, the method comprising:
receiving an input signal;
modulating a sampling frequency of an artificial neuron based on the input signal; and
forwarding the input signal or a further input signal obtained from the input signal to the artificial neuron at the sampling frequency,
wherein said modulating the sampling frequency comprises one or both of increasing the sampling frequency with an increased input signal and reducing the sampling frequency with a decreased input signal.

2. The method of claim 1, wherein said modulating the sampling frequency comprises modulating the sampling frequency based on an amplitude of the input signal and one or more reference sampling frequencies, wherein the reference sampling frequencies are determined at a plurality of preselected input signal amplitudes, whereby an output or output signal of the artificial neuron from each said preselected input signal amplitude is substantially stable at or above the associated reference sampling frequency.

3. The method of claim 1, wherein said modulating the sampling frequency comprises selecting one of two or more predefined sampling frequencies based on an amplitude of the input signal, each said predefined sampling frequency being selected for a range of the amplitude of the input signal, whereby the output or output signal of the artificial neuron from the amplitude of the input signal in at least a portion of the range is substantially stable at or about the associated predefined sampling frequency.

4. The method of claim 2, wherein said modulating the sampling frequency comprises selecting one of two or more predefined sampling frequencies obtained from the reference sampling frequencies, each said predefined sampling frequency being selected for a range of the amplitude of the input signal, whereby the output or output signal of the artificial neuron from the amplitude of the input signal in at least a portion of the range is substantially stable at or about the associated predefined sampling frequency.

5. The method of claim 4, wherein each said predefined sampling frequency is substantially equal to at least one said reference sampling frequency determined at the associated preselected input signal amplitude falling within the associated range.

6. The method of claim 3, wherein the output or output signal of the artificial neuron from the amplitude of the input signal in the range is substantially stable at or about the associated predefined sampling frequency.

7. The method of claim 2, wherein said modulating the sampling frequency comprises: i) modulating the sampling frequency to be about equal to or greater than one said reference sampling frequency if the amplitude of the input signal is substantially identical to one said preselected input signal amplitude associated with the reference sampling frequency; and ii) if the amplitude of the input signal is different from all said preselected input signal amplitudes, modulating the sampling frequency to be about equal to or great than an estimated sampling frequency interpolated or extrapolated from one or more said reference sampling frequencies.

8. The method of claim 1, wherein the input signal is an input current.

9. The method of claim 1, wherein the artificial neural network is a spiking neural network.

10. The method of claim 1, wherein the artificial neural network comprises a digital neuron model selected from the group consisting of Adaptive-Exponential Integrate-and-Fire model, Izhikevich model, Hodgkin-Huxley model, Leaky Integrate-and-Fire model, Thorpe's model, probabilistic and stochastic spiking neuron model and probabilistic neurogenetic model.

11. The method of claim 10, wherein the digital neuron model is Adaptive-Exponential Integrate-and-Fire model or Izhikevich model, and said modulating the sampling frequency comprises selecting the sampling frequency between dt= 1/4096 ms and dt=8 MS.

12. The method of claim 1, wherein the method is operable to reduce power consumption in the artificial neural network.

13. A method for operating a spiking neural network, the method comprising:
receiving an input current;
determining a time step based on the input current;
starting a timer; and
forwarding the input current to an artificial neuron when the timer reaches the time step for a time period selected for the artificial neuron to perform a single evaluation.

14. The method of claim 13, wherein the spiking neural network comprises a digital neuron model selected from the group consisting of Adaptive-Exponential Integrate-and-Fire model, Izhikevich model, Hodgkin-Huxley model, Leaky Integrate-and-Fire model, Thorpe's model, probabilistic and stochastic spiking neuron model and probabilistic neurogenetic model.

15. The method of claim 14, wherein the digital neuron model is Adaptive-Exponential Integrate-and-Fire model or Izhikevich model, and said determining the time step comprises determining the time step between dt= 1/4096 ms and dt=8 ms.

16. The method of claim 13, wherein said determining the time step comprises determining the time step generally inversely exponentially proportional to the input current.

17. The method of claim 13, wherein said determining the time step comprises determining the time step based on the input current and one or more reference time steps, wherein the reference time steps are determined at a plurality of preselected input currents, whereby an output or output signal of the artificial neuron from each said preselected input current is substantially stable at or lower than the associated time step.

18. The method of claim 13, wherein said determining the time step comprises selecting one of two or more predefined time steps based on the input current, each said predefined time step being selected for a range of the input current, whereby the output or output signal of the artificial neuron from the input current in at least a portion of the range is substantially stable at or about the associated predefined time step.

19. The method of claim 17, wherein said determining the time step comprises selecting one of two or more predefined time steps obtained from the reference time steps, each said predefined time step being selected for a range of the input current, whereby the output or output signal of the artificial neuron from the input current in at least a portion of the range is substantially stable at or about the associated predefined time step.

20. The method of claim 19, wherein each said predefined time step is substantially equal to at least one said reference time step determined at the associated preselected input current falling within the associated range.

21. The method of claim 19, wherein the output or output signal of the artificial neuron from the input current in the range is substantially stable at or about the associated predefined time step.

22. The method of claim 17, wherein said determining the time step comprises: i) determining the time step to be about equal to or lower than one said reference time step if the input current is substantially identical to one said preselected input current associated with the reference time step; and ii) if the input current is different from all said preselected input currents, determining the time step to be about equal to or lower than an estimated time step interpolated or extrapolated from one or more said reference time steps.

23. A spiking neural network comprising an input-dependent variable sampling module and a digital neuron module, the input-dependent variable sampling module being configured to:
receive an input current to be compared to a threshold value and select a first predefined time step if the input current is less than the threshold value and a second predefined time step if the input current is more than the threshold value;
start a timer; and
forward the input current to the digital neuron module when the timer reaches a selected one of the first and second predefined time steps for a time period selected for the digital neuron module to perform a single evaluation,
wherein the first predefined time step is longer than the second predefined time step.
